(19) United States
(12) Patent Application Publication
(10) Pub. No.: US 2010/0185985 A1
(43) Pub. Date: Jul. 22, 2010

(54) MANAGING RADIAL MENUS IN A COMPUTER SYSTEM

(75) Inventors: Paul R. Chmielewski, Byron, MN (US); Brian J. Cragun, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: International Business Machines Corporation, ARMONK, NY (US)

(21) Appl. No.: 12/355,974

(22) Filed: Jan. 19, 2009

(51) Int. Cl. G06F 3/048

(52) U.S. Cl. 715/834

(57) ABSTRACT

The present invention is generally related to graphical user interfaces (GUIs), and more specifically to displaying items in a radial menu. A radial menu may be displayed in a display screen including a first set of radial menu items. A screen object may also be displayed in the display screen. A second set of radial menu items may be displayed in the radial menu when a screen pointer event occurs over the screen object.

### BACKGROUND OF THE INVENTION

1. Field of the Invention

The present invention is generally related to graphical user interfaces (GUIs), and more specifically to displaying items in a radial menu.

2. Description of the Related Art

Most modern computers include applications that allow a user to interact with the application while performing operations associated with the applications. For example, an application may be configured to receive commands from the user to display data, modify data, initiate a particular task, and the like. In the past, user interaction with applications was facilitated by a command line interface. The command line interface allowed users to type predefined commands to interact with an application. However, command line interfaces require users to memorize large lists of commands to communicate with each application.

More recently, user interaction with applications has involved the use of graphical user interfaces, or GUIs. For example, most applications today are configured to display a window including a menu bar on a display screen. The menu bar may include one or more pull down menus including lists of functions and commands that may be used to interact with the application.

### SUMMARY OF THE INVENTION

The present invention is generally related to graphical user interfaces (GUIs), and more specifically to displaying items in a radial menu.

One embodiment of the invention provides a computer-implemented method of displaying a radial menu. The method generally comprises receiving a predefined screen pointer event for displaying a radial menu and, in response to receiving the predefined screen pointer event, displaying the radial menu and at least one screen object on a display screen, wherein the displayed radial menu comprises a first set of radial menu items. The method further comprises receiving a screen pointer gesture, wherein the gesture comprises moving the screen pointer over the at least one screen object, and in response to detecting that the screen pointer is over the at least one screen object, displaying a second set of radial menu items in the radial menu.

Another embodiment of the invention provides a computer readable storage medium comprising a program product which, when executed by a processor, is configured to perform an operation for displaying a radial menu. The operation generally comprises receiving a predefined screen pointer event for displaying a radial menu and, in response to receiving the predefined screen pointer event, displaying the radial menu and at least one screen object on a display screen, wherein the radial menu comprises a first set of radial menu items. The operation further comprises receiving a screen pointer gesture, wherein the gesture comprises moving the screen pointer over the at least one screen object, and in response to detecting that the screen pointer is over the at least one screen object, displaying a second set of radial menu items in the radial menu.

Yet another embodiment of the invention provides a system, generally comprising a memory comprising a program and a processor. The processor, when executing the program, is generally configured to receive a predefined screen pointer event for displaying a radial menu, and in response to receiving the predefined screen pointer event, display the radial menu and at least one screen object on a display screen, wherein the radial menu comprises a first set of radial menu items. The processor is further configured to receive a screen pointer gesture, wherein the gesture comprises moving the screen pointer over the at least one screen object, and in response to detecting that the screen pointer is over the at least one screen object, display a second set of radial menu items in the radial menu.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates a drop-down menu according to the prior art.

FIG. 2 illustrates an exemplary system according to an embodiment of the invention.

FIG. 3 illustrates an exemplary radial menu according to an embodiment of the invention.

FIGS. 4A-4C illustrate further exemplary radial menus according to embodiments of the invention.

FIG. 5 illustrates an exemplary screen pointer event for displaying a radial menu, according to an embodiment of the invention.

FIG. 6 illustrates an exemplary stroke according to an embodiment of the invention.

FIGS. 7A-7C illustrate exemplary strokes for selecting a radial menu item, according to an embodiment of the invention.

FIG. 7D illustrates an exemplary graphical user interface for defining gestures, according to an embodiment of the invention.

FIG. 8 illustrates an exemplary selection zone according to an embodiment of the invention.

FIG. 9 illustrates another exemplary selection zone according to an embodiment of the invention.

FIG. 10A-B illustrate exemplary overloading of a radial menu according to an embodiment of the invention.

FIGS. 11A-B illustrate exemplary overloading of a radial menu according to another embodiment of the invention.

FIGS. 12A-B illustrate exemplary overloading of a radial menu according to yet another embodiment of the invention.

FIG. 13 illustrate exemplary overloading of a radial menu according to a further embodiment of the invention.

FIG. 14 is a flow diagram of exemplary operations performed while displaying an overloaded radial menu according to an embodiment of the invention.

### DETAILED DESCRIPTION OF THE PREFERRED EMBODIMENTS

The present invention is generally related to graphical user interfaces (GUIs), and more specifically to displaying items in a radial menu. A radial menu may be displayed in a display screen including a first set of radial menu items. A screen object may also be displayed on the display screen. A second set of radial menu items may be displayed in the radial menu when a screen pointer event occurs over the screen object.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

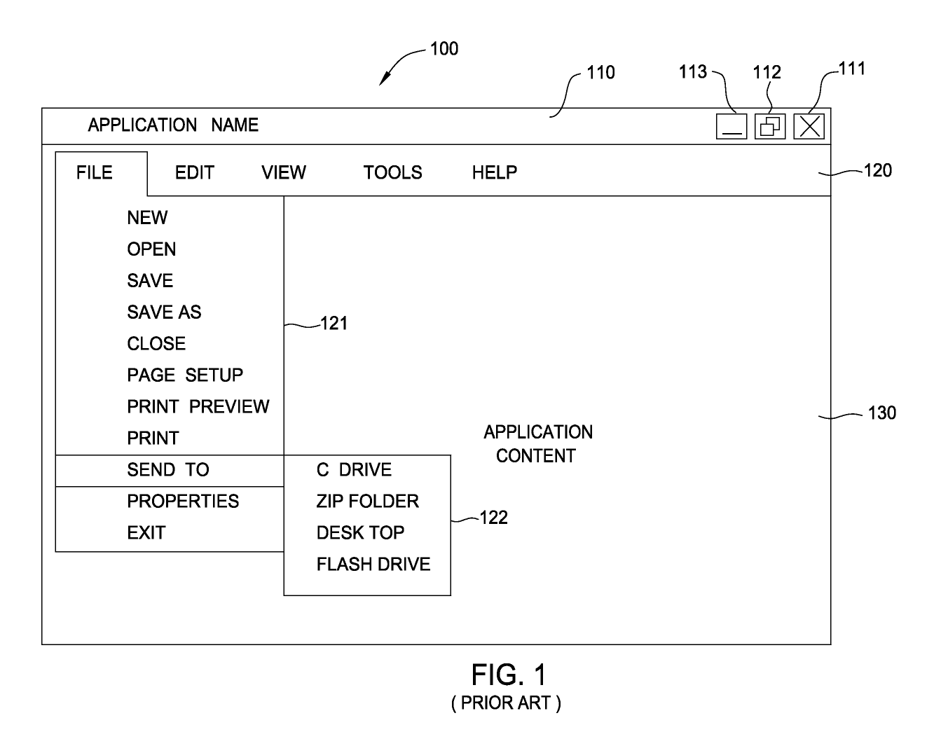

FIG. 1 illustrates an exemplary graphical user interface (GUI) 100 according to the prior art. GUI 100 may be displayed on a display screen, such as, for example, a computer monitor to facilitate communication between a user and an application. As illustrated in FIG. 1, GUI 100 includes a title bar 110, a menu bar 120, and an application content area 130. The application content area 130 includes graphical representations of application content including text, images, video, spreadsheets, and the like.

The title bar 110 displays the application name and one or more buttons, including a close button 111, a maximize/restore button 112, and a minimize/restore 113. The close button, when clicked, may be configured to close the application, the maximize/restore button 112 may be configured to toggle the size of the GUI 100 between two predefined sizes (for example, a sized window and a maximized window), and the minimize/restore button 113 may be configured to reduce the GUI 100 into, for example, a task bar.

The menu bar 120 includes a plurality of menus including the File menu, Edit menu, View menu, Tools menu, and Help menu, as illustrated in FIG. 1. A particular menu may be selected from the menu bar, for example, by clicking on a desired menu using a mouse. Each of the menus in the menu bar 120 are drop down menus. Therefore, when a particular menu is selected, a list of items in the menu is displayed. FIG. 1, illustrates an exemplary list of items 121 displayed when the File menu is selected.

A particular item may be selected from a drop down menu by moving the mouse pointer vertically up and down the list until the mouse pointer is above a desired item. In some cases a visual indication of the particular item under the mouse pointer may be provided. For example, as illustrated in FIG. 1, a mouse pointer 150 is over the Send To item of the File menu. Therefore, the Send To item is shaded with a different colored background to indicate that the mouse pointer is over the Send To item.

Selecting a menu item may include performing a second mouse click to select the desired item. For example, a first mouse click on a desired menu may display menu items in a drop down list. A user may then move a mouse pointer vertically up and/or down until the mouse pointer is over a desired menu item. A visual indication, for example, shading may indicate the item over which the mouse pointer lies to aid the user in making the selection. Once the mouse pointer is above the desired menu item, a second click of the mouse may result in the selection of the menu item.

In some cases, a menu item may be a sub-menu. For example, the Send To item of the File Menu may be a sub-menu. Accordingly, as illustrated in FIG. 1, moving the mouse pointer over the Send To item may result is a cascaded sub-menu 122 to be displayed. Each cascaded sub-menu may have its own cascaded sub menu, which may result in several cascaded sub-menus being displayed before the desired item is selected.

The GUI 100 provides several advantages over traditional command line interfaces. For example, a user of the GUI 100 need not memorize commands associated with a large number of menu items because he/she may simply explore and navigate the menu items via the menu bar to communicate with the application. However, menu bars and drop down menus are not efficient at allowing a user to quickly select a desired item. First, selecting a menu item requires at least two mouse clicks as described above. Second, in drop down menus having a large number of items, the menu items may be closely spaced, which may require the user to scan up and down along the menu several times before a desired item is found. Furthermore, drop down menus with a large number of closely spaced items have an increased probability of erroneous selection of menu items.

The inefficiency of drop down menus may adversely affect users of applications where a fast response time is desired from the user while interacting with the applications. For example, in a gaming application a user's response time in responding to a particular circumstance in the game may be critical to the user's performance in the game. As an example, in a game where performance is determined by the user's ability to defeat opponents in a fight, the ability of the user to detect and quickly attack opponents may be crucial to performing successfully completing the game.

Embodiments of the invention provide radial menus that allow users to quickly make selections of menu items using simple gestures. A radial menu may be displayed on a display screen in response to detecting a predefined screen pointer event such as a mouse click. Other screen pointer events may include touching the display screen with a finger or stylus pen, pressing one or more keys on a keyboard, receiving a voice command, and the like. Thereafter, a first stroke may be made with the screen pointer to activate a desired radial menu item. A predefined second stroke may be made to select the active radial menu item.

### Exemplary System

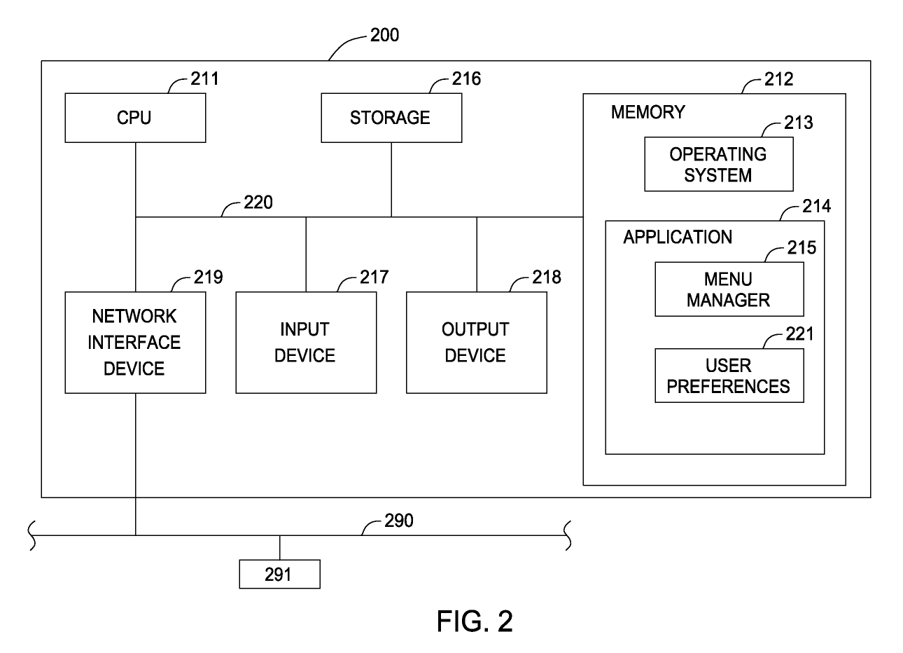

FIG. 2 depicts a block diagram of a system 200 in which embodiments of the invention may be implemented. The system 200 may include a Central Processing Unit (CPU) 211 connected via a bus 220 to a memory 212, storage 216, an input device 217, an output device 218, and a network interface device 219. The input device 217 can be any device to give input to the system 200. For example, a keyboard, keypad, light-pen, touch-screen, track-ball, or speech recognition unit, audio/video player, and the like could be used. The output device 218 can be any device to give output to the user, e.g., any conventional display screen. Although shown separately from the input device 217, the output device 218 and input device 217 could be combined. For example, a display screen with an integrated touch-screen, a display with an integrated keyboard, or a speech recognition unit combined with a text speech converter could be used.

The network interface device 219 may be any entry/exit device configured to allow network communications between the system 200 and one or more other devices 291 via a network 290. For example, the network interface device 119 may be a network adapter or other network interface card (NIC).

Storage 216 is preferably a Direct Access Storage Device (DASD). Although it is shown as a single unit, it could be a combination of fixed and/or removable storage devices, such as fixed disc drives, floppy disc drives, tape drives, removable memory cards, or optical storage. The memory 212 and storage 216 could be part of one virtual address space spanning multiple primary and secondary storage devices.

The memory 212 is preferably a random access memory sufficiently large to hold the necessary programming and data structures of the invention. While memory 212 is shown as a single entity, it should be understood that memory 212 may in fact comprise a plurality of modules, and that memory 212 may exist at multiple levels, from high speed registers and caches to lower speed but larger DRAM chips.

Illustratively, the memory 212 contains an operating system 213. Illustrative operating systems, which may be used to advantage, include Linux (Linux is a trademark of Linus Torvalds in the US, other countries, or both) and Microsoft's Windows®. More generally, any operating system supporting the functions disclosed herein may be used.

Memory 212 may also include one or more applications 214. The applications 214 may be software products comprising a plurality of instructions that are resident at various times in memory and storage devices in the computer system 200. When read and executed by one or more CPU 211, the applications 214 may cause the computer system 200 to perform the steps necessary to execute steps or elements embodying the various aspects of the invention.

In one embodiment, the applications 214 may include a menu manager program 215, which may be configured to display a radial menu on the output device 218, and detect selection of one or more radial menu items, as is discussed in greater detail below. In some embodiments the application program 214 and menu manager 215 may reside on a networked computer device 291 and may be configured to manage radial menus on the output device 118 of computer system 200. The applications 214 may also include user preferences 221. The user preferences 221 may determine one or more characteristics of radial menus, for example, the displaying of radial menus, making selections from radial menus, and the like, as will be discussed in greater detail below.

### Exemplary Radial Menus

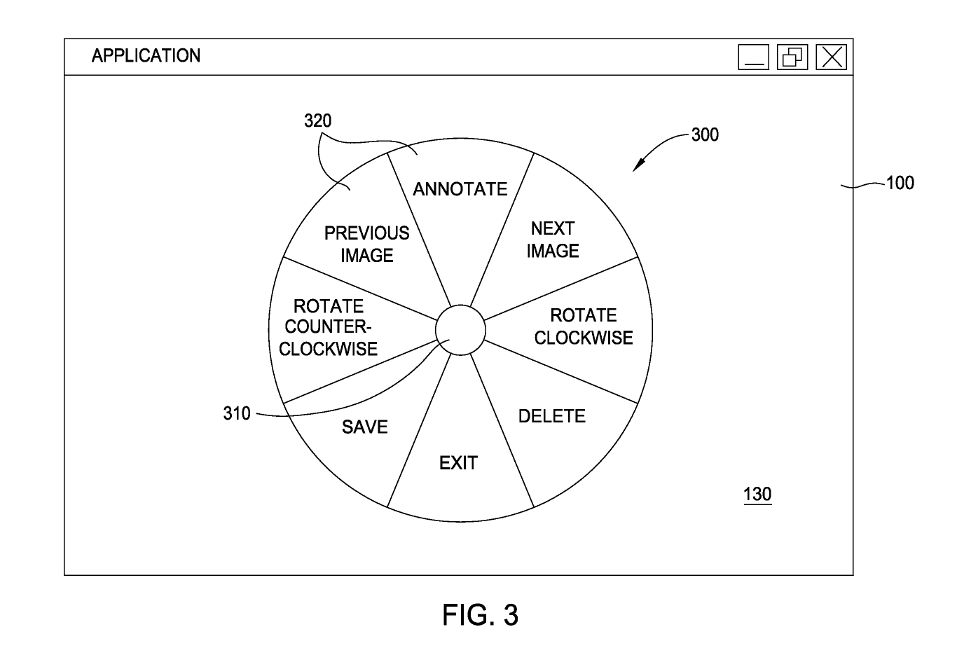

FIG. 3 illustrates an exemplary radial menu 300, according to an embodiment of the invention. In one embodiment, the radial menu 300 may be displayed in an application window 100 by the menu manager 215, as illustrated in FIG. 3. However, in alternative embodiments, the menu manager 215 may be configured to display the radial menu 300 at any location on a screen, whether inside or outside a window.

In general, the radial menu 300 may include a center 310 and a plurality of radial menu items 320 placed radially outwards from the center 310. For purposes of illustration, the radial menu 300 is assumed to be associated with an image editing software. Accordingly, the radial menu items 320 displayed in FIG. 3 include “Previous Image”, “Next Image”, “Annotate”, “Rotate Clockwise”, “Rotate Counterclockwise”, “Save”, “Exit”, and “Delete”. In a particular embodiment, the radial menu 300 may include between 6 and 8 radial menu items, however, any reasonable number of radial menu items may be included in the radial menu 300 in other embodiments.

The radial menu items 320 may be selected by using a screen pointer such as, for example, a mouse pointer, a stylus pen, trackball pointer, a human finger, and the like, as is described in greater detail below. Each of the radial menu items 320 may be associated with commands and/or functions that may be used to communicate with an application 114 associated with the radial menu 300. For example, the “Next Image” radial menu item, when selected, may cause a new image to be displayed in an application content area 130 of window 100 in FIG. 3. As another example, the “Annotate” radial menu item, when selected, may launch a function that may allow a user to insert annotations for an image displayed in the application content area 130. In some embodiments, selecting a radial menu item may result in a second or cascaded radial menu to be displayed.

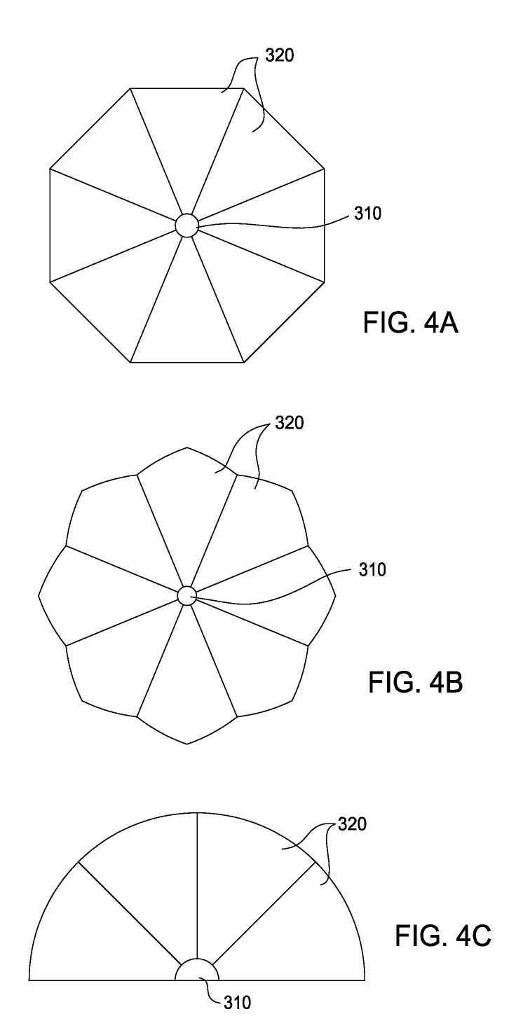

In one embodiment of the invention, the radial menu items 320 may be displayed as “pie slices” 320, as illustrated in FIG. 3. However, in alternative embodiments, the radial menu items may have any reasonable shape that allows a plurality of radial menu items 320 to be displayed radially outwards from the center 310. FIGS. 4A and 4B, illustrate some alternative shapes for the radial menu items 320. Furthermore, while a circular radial menu 300 is illustrated in FIG. 3, in alternative embodiments, the radial menu 300 may be semicircular, quadra circular, or any other radial shape. For example, FIG. 4C illustrates a semicircular radial menu, according to an embodiment of the invention.

The radial menu 300 may be a pop-up menu that is displayed upon the occurrence of a predefined screen pointer event. For example, in one embodiment, the menu manager 215 may be configured to display the radial menu 300 on a screen (for example, in window 100) upon detecting a mouse click. In a particular embodiment, the radial menu 300 may be displayed when a right button of a mouse is clicked. While using mouse clicks to display radial menus is described herein, alternative screen pointer events that may cause a radial menu to appear may include, for example, touching a screen with a stylus pen or finger, pressing one or more keys on a keyboard, receiving a voice command, and the like.

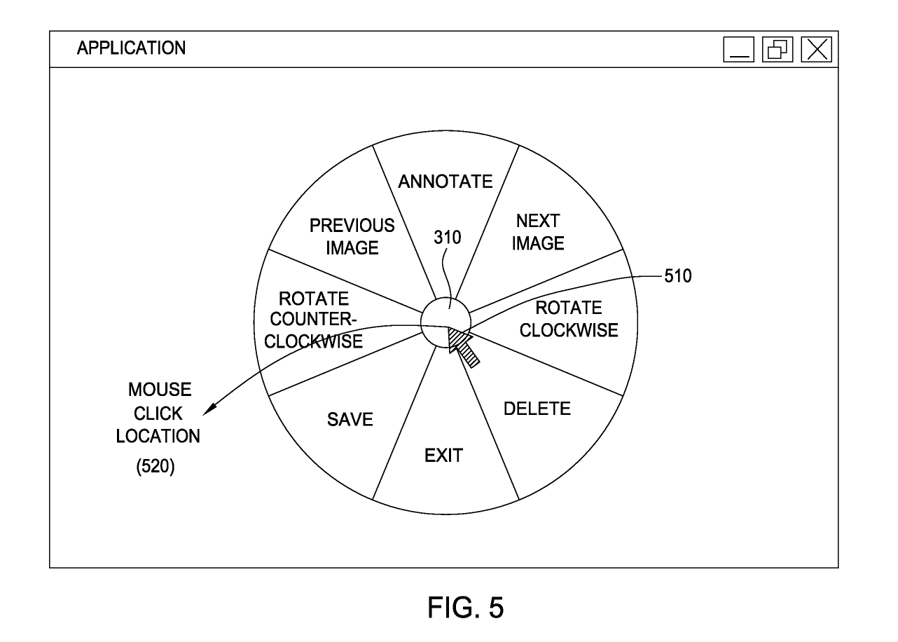

In one embodiment of the invention, the menu manager 215 may display the radial menu such that the center of the radial menu aligns with the screen pointer. FIG. 5 illustrates a radial menu 300 displayed such that the center 310 of the radial menu 300 aligns with a location 520 of a screen pointer 510. As illustrated in FIG. 5, the screen pointer may be a mouse pointer and the location 520 may be a location of the mouse pointer when the mouse is clicked. Alternatively the location 520 may be the location where a stylus pen or finger touches a display screen.

Selection of a radial menu item from a radial menu may involve moving the screen pointer 510 in the direction of a desired radial menu item 320. For example, to select the “Annotate” radial menu item, the screen pointer may be moved straight up (in a generally 90 degrees direction) towards the pie slice of the “Annotate” radial menu item. The moving of the screen pointer on the display screen is generally referred to hereinafter as a “stroke”. In the case of a mouse pointer, strokes may be performed by simply moving the mouse on a mouse pad. While using a stylus pen or finger on a touch screen, the finger or stylus pen may simply be dragged across the screen to perform a stroke.

Placing the screen pointer over a radial menu item 320 may cause the radial menu item to become active. When a radial menu item 320 is active, the occurrence of a selection event, such as, for example, a mouse click, may cause the radial menu item 320 to be selected. In one embodiment of the invention, the menu manager 215 may be configured to provide a visual indication to identify an active radial menu item.

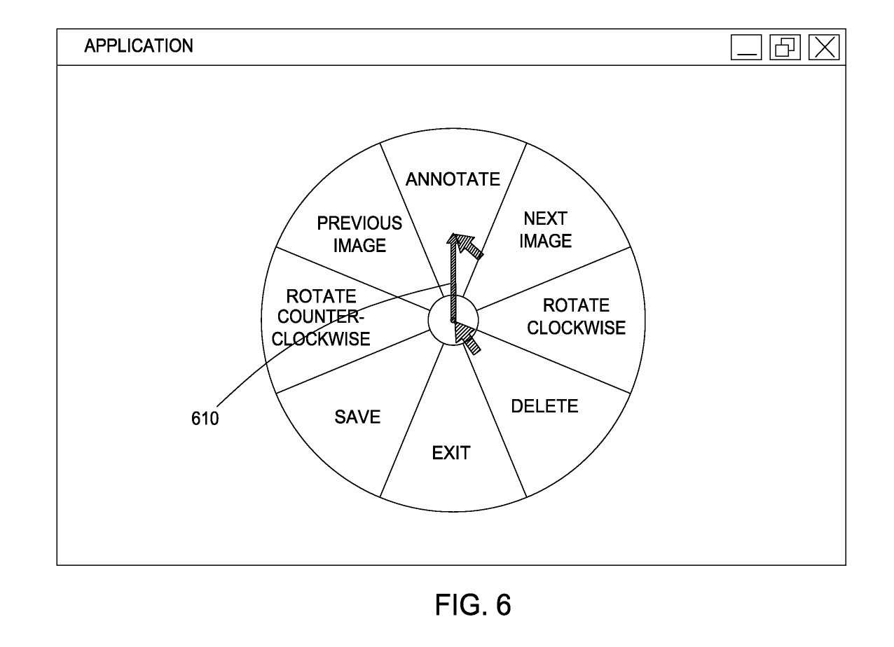

FIG. 6 illustrates an exemplary stroke 610 which results in the activation of a radial menu item, according to an embodiment of the invention. As illustrated in FIG. 6, the stroke 610 moves the screen pointer over the “Annotate” radial menu item. As a result, the menu manager 215 may change the background color of the “Annotate” pie slice, which is indicated by the shading of the “Annotate” pie slice in FIG. 6. The change in color may identify the “Annotate” radial menu item as the active item. Other methods for providing a visual indication such as, for example, bold facing the letters of the active radial menu item, dimming or fading the pie slices or letters of non-active radial menu items, and the like, are also contemplated. While a straight line stroke is illustrated in FIG. 6, the stroke 610 may include any movement in any and/or multiple directions on a display screen in alternative embodiments.

In one embodiment, the center 310 of the radial menu 300 may be an inactive center. In other words, no radial menu items 320 may be active while the screen pointer 510 lies over the center portion 310. Therefore, when the menu manager 215 aligns the center 310 of the radial menu when the radial menu is displayed as described above, no radial menu items 320 may be initially active. Thereafter, user strokes may cause one or more radial menu items to become active. If the user strokes return the screen pointer to the center 310, all radial menu items may again become inactive.

One embodiment of the invention may allow radial menu items 320 to be selected in a single gesture. In general, a gesture may include at least one or more strokes. Additionally, in some embodiments, a gesture may include one or more screen pointer events such as, for example, mouse click downs (pressing a mouse button), mouse click offs (releasing the mouse button), touching a screen with a stylus pen or finger, removing stylus pen or finger from the screen and the like. The menu manager 215 may be configured to analyze gestures performed on a display screen to determine whether a radial menu item is selected. In one embodiment, a plurality of predefined gestures may correspond to respective menu item selections.

For example, an exemplary gesture for selecting a radial menu item may include performing a first mouse click, i.e., a mouse button click down and release. The first mouse click may display a radial menu, for example, the radial menu 300 on the display screen. Thereafter, one or more strokes may be performed to move the mouse pointer over a desired radial menu item 320. As discussed above, menu manager 215 may provide a visual indication that the desired radial menu item is active. When the mouse pointer is over the desired radial menu item, the mouse may be clicked a second time. Because the second mouse click occurred while the mouse pointer is above a radial menu item 320, the menu manager may determine that a radial menu item selection has occurred. Therefore, the menu manager 215 may cause a command or function associated with the selected radial menu item to be executed. In this example, the combined events of the first mouse click, the subsequent one or more strokes, and the second mouse click define the exemplary gesture.

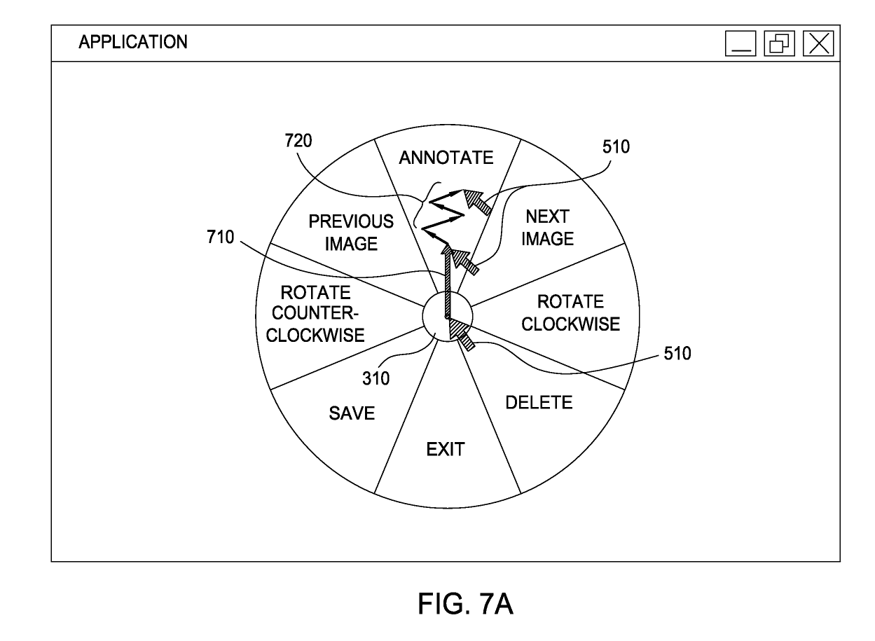

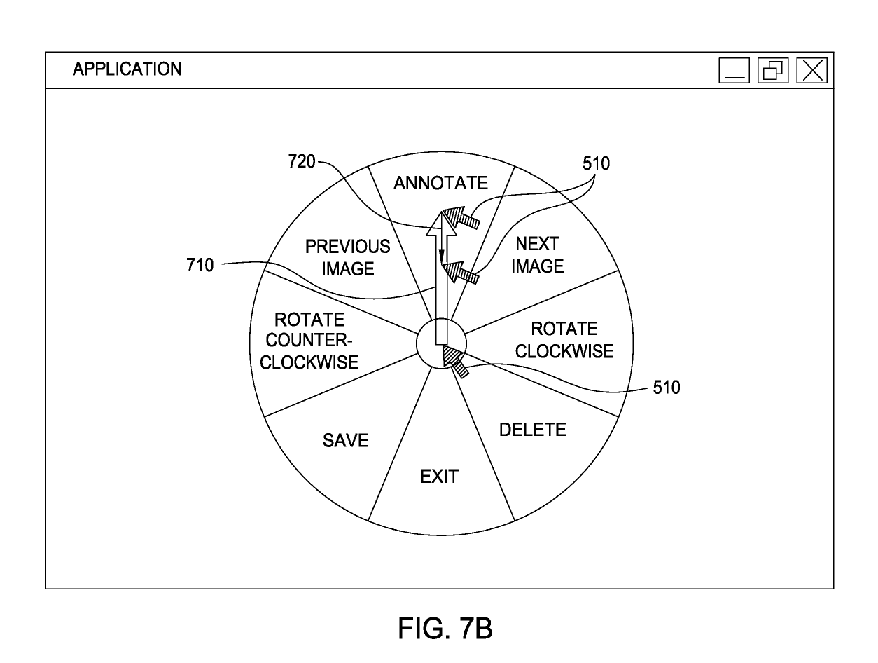

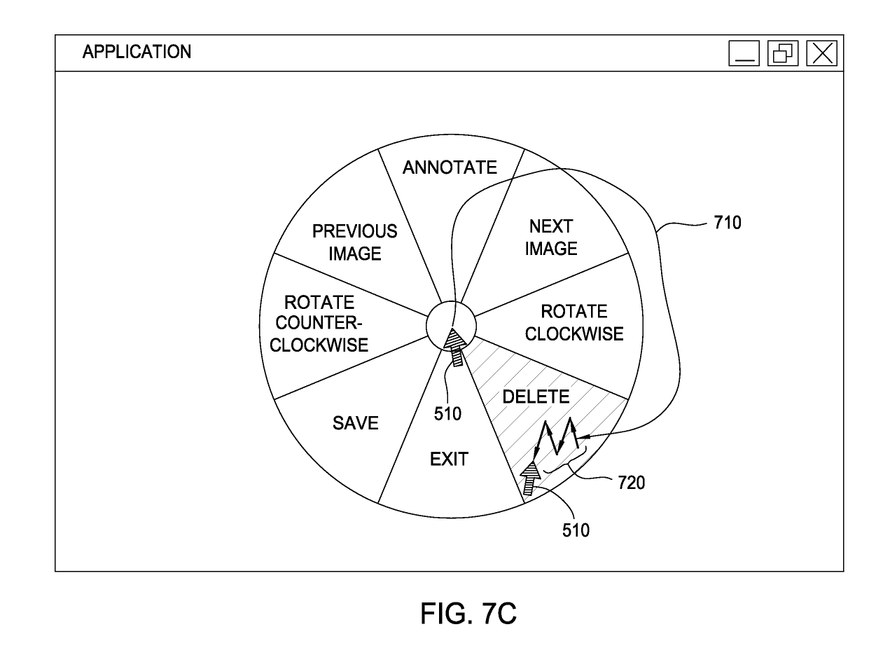

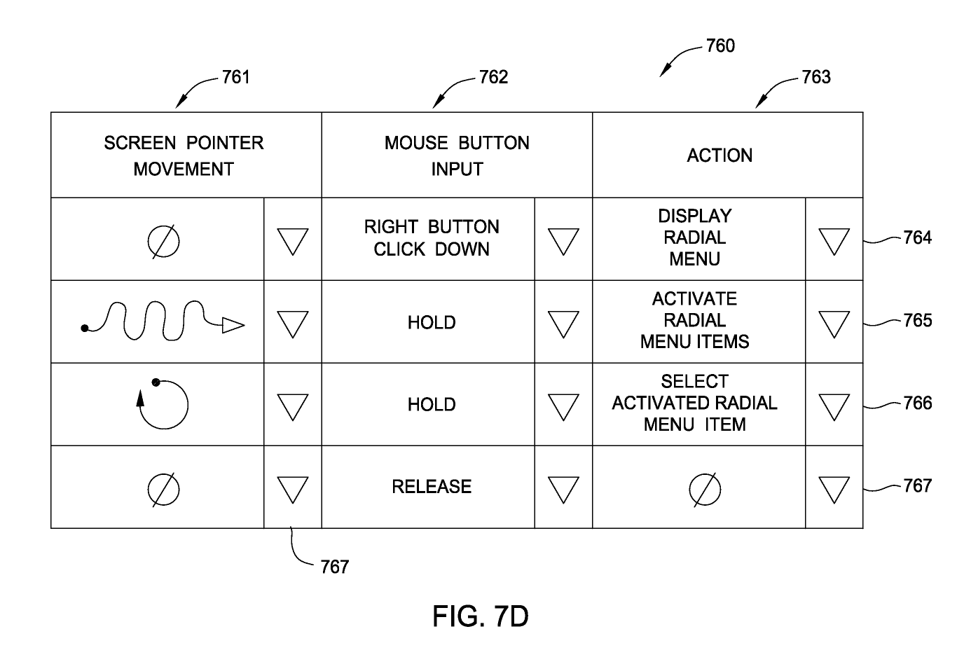

In one embodiment of the invention, a gesture for selecting a radial menu item may include a first mouse click (i.e., a mouse click down and release) that causes a radial menu to be displayed on the display screen, a first stroke configured to activate a radial menu item, and a predefined second stroke that is configured to select the radial menu item. FIG. 7A illustrates exemplary first and second strokes according to an embodiment of the invention. As illustrated in FIG. 7A, a first stroke 710 may move the screen pointer 510 from a center 310 of the radial menu to the “Annotate” radial menu item. Thereafter, a predefined second stroke may be performed to select the “Annotate” radial menu item. As illustrated in FIG. 7A, predefined second stroke may involve moving the screen pointer in a zigzag back and forth motion over a same path. If the predefined back and forth motion is detected by the menu manager while the screen pointer is over a radial menu item, the radial menu item may be selected.

Any reasonable predefined movement of the screen pointer 510 may be used as a radial menu selection event. FIG. 7B illustrates an alternative predefined second motion that may result in the selection of a radial menu item. As illustrated in FIG. 7B, a first stroke may move the screen pointer 510 from a center 310 of the radial menu to the “Annotate” radial menu item. A predefined second stroke may move the screen pointer back in a direction towards the center 310, which may result in the selection of the “Annotate” radial menu item. Still another alternative predefined second strokes may include substantially circular and/or semi-circular movement of the screen pointer over the radial menu item.

In another embodiment, the gesture for selecting a radial menu item may involve a mouse button click down (without release), a first stroke for activating a radial menu item, and a second predefined stroke for selecting the radial menu item. The mouse button may be released after selection of the radial menu item. The mouse button click down may cause a radial menu to be displayed. The first stroke and predefined second stroke may function as described above.

In some embodiments, if a second predefined stroke is not received within a predefined period of time after activation of the radial menu, the menu manager 215 may be configured to close the radial menu. Closing the radial menu may involve removing the radial menu from the display screen. In some embodiments, the predefined period of time may begin after completion of the first stroke. For example, a screen pointer event may cause the radial menu to be displayed. Thereafter, a first stroke may be completed to activate a radial menu item. If the predefined second stroke is not received within the predefined period of time after completion of the first stroke, the radial menu may be closed by the menu manager 215.

In yet another embodiment, the menu manager 215 may select an active radial menu item if the radial menu item has been active for a predefined period of time. Accordingly, the gesture for selecting a radial menu item may involve a mouse button click down (with or without release), and a first gesture for activating a radial menu item. The mouse button click down may cause a radial menu to be displayed. The first stroke may function as described above to activate a radial menu item. The menu manager 215 may monitor the time for which a particular radial menu item has been active, and select the radial menu item after the predefined period of time.

While the first stroke is illustrated as a straight line from the center 310 of the radial menu to a desired radial menu element 320, in some embodiments, the first stroke may include movement along any part of the display screen. For example, a user may initially move the screen pointer in the direction of a first radial menu item, but then decide to choose a second radial menu item instead. Accordingly, the user may move the screen pointer across the screen until the desired second radial menu item is activated. Once the second radial menu item is activated, the user may perform the predefined second stroke to select the second radial menu item.

FIG. 7C illustrates exemplary first and second strokes according to another embodiment of the invention. As illustrated in FIG. 7C, the first stroke 710 may include an initial movement towards a first radial menu item (“Annotate”). The first stroke 710 may continue to move across the screen until a second radial menu item (“Delete”) is activated, as indicated by the shading. Thereafter, a predefined second stroke 720 may be performed to select the second radial menu item. In some embodiments, the first stroke may include movement over multiple radial menu items until a desired radial menu item is activated.

In one embodiment of the invention, a gesture for selecting a radial menu item may include a first mouse click (i.e., a mouse click down and release) that causes a radial menu to be displayed on the display screen, and a first stroke configured to activate and select the radial menu item. The first stroke may activate a menu item 320 when the mouse pointer is moved thereon. Furthermore, the menu manager 215 may be configured to analyze a speed of the screen pointer during the first stroke. If the speed exceeds (or falls below) a predefined threshold value, the activated radial menu item may be selected. The threshold speed values may be user configurable in some embodiments. For example, the threshold speed values may be defined by a user in the user preferences 221 (See FIG. 2).

In one embodiment of the invention, a user may be allowed to define the particular gesture for selecting items from a radial menu. For example, in one embodiment, the application 114 may be configured to display a graphical user interface that allows a user to define a gesture for selecting radial menu items. The user defined gesture may be stored in the user preferences 221, in one embodiment. FIG. 7D, illustrates an exemplary graphical user interface for defining a gesture for selecting radial menu items. As illustrated in FIG. 7D, the user preferences 221 may include a first column for defining screen pointer movement (or strokes), a second column 762 for defining mouse button input, and a third column 763 for defining an action performed based on the defined inputs in columns 761 and 762.

As illustrated in FIG. 7D, the GUI 760 may include a plurality of drop down menus 767 for defining the particular inputs and the actions performed in response to the inputs. Alternatively, the GUI may include radio buttons, text boxes, check boxes, and the like for defining the inputs and actions. In some embodiments, the GUI 760 may include a screen where the input (for example, strokes and mouse clicks) may be performed to define the inputs and/or actions.

The first row 764 defines an exemplary screen pointer event, i.e., right mouse button click down, that results in a radial menu being displayed. Alternatively, a right mouse button click down and click off may also be selected as a predefined screen pointer event for displaying a radial menu. As can be seen in row 764 of FIG. 7D, the no screen pointer movement has been defined. In alternative embodiments, the user may define a screen pointer movement for displaying the radial menu instead of (or in addition to) the right button mouse click down.

Row 765 illustrates inputs for activating radial menu items. As illustrated, radial menu items may be activated when the right mouse button is held down and the screen pointer is moved in any direction as illustrated by the symbol in row 765, column 761. Alternatively, a user may choose to select a straight line movement of the screen pointer for selecting radial menu items. Row 766 illustrates a predefined second stroke, i.e., a circular stroke, for selecting a radial menu item. Row 767 illustrates a mouse button click off. While no action is shown for the mouse button click off on FIG. 7D, in some embodiments, the mouse button click off may result in predefined action, for example, selection of the radial menu item, removing of the radial menu from the display screen, or the like.

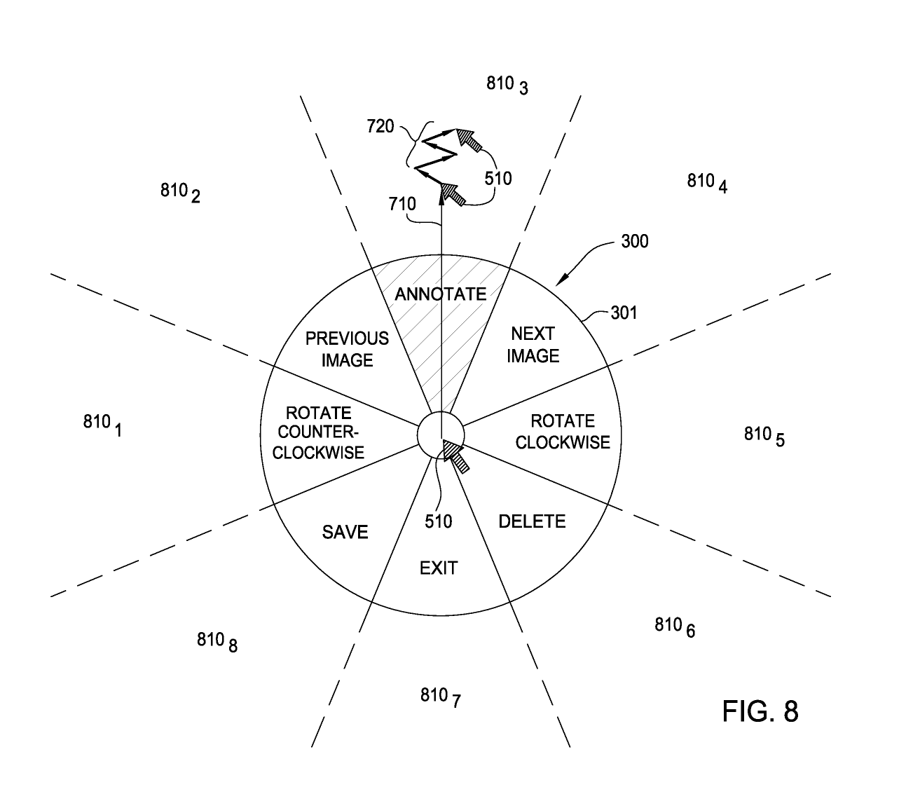

In one embodiment of the invention, it may be possible to select radial menu items even though a selection event occurs outside the bounds of the radial menu. FIG. 8 illustrates an exemplary radial menu 300 comprising a plurality of extra-territorial zones 810₁₋₈ associated with respective radial menu items 320. As shown in FIG. 8, the zones 810₁₋₈ may be outside the visible bounds of the radial menu 300. As shown in FIG. 8, the outside bounds of the radial menu 300 are demarcated by a circle 301. The circle 301 is merely illustrative. In other embodiments, any visible geometric shape 301 is contemplated. In one embodiment of the invention, if a screen pointer is in a zone 810, the radial menu item 320 associated with the zone 810 may be active. Accordingly, if a selection event occurs in the zone 810, a selection of the radial menu item associated with the zone 810 may occur. In other words, a pie slice of the radial menu item 320 and a respective zone 810 may define a selection zone of a radial menu item within which gestures may be performed for selection of the radial menu item.

For example, FIG. 8 illustrates a first stroke 810 which moves the screen pointer 510 across the “Annotate” radial menu item pie slice and into the zone 810₃ associated with the “Annotate” radial menu item. As can be seen in FIG. 8, the “Annotate” radial menu item remains active even though the screen pointer is outside the bounds of the radial menu 300. Further as depicted in FIG. 8, a predefined second stroke 720 may occur in the zone 810₃ associated with the “Annotate” radial menu item. The menu manager 215 may detect the predefined second stroke in the zone 810₃ and cause the respective “Annotate” radial menu item to be selected.

Allowing users to make elongated first strokes such as, for example, the elongated first stroke 710 in FIG. 8 may reduce errors in selection of radial menu items. As can be seen in FIG. 8, the further the screen pointer is moved from the center 310 of the radial menu, the greater the area that is available for making gestures such as, for example, the predefined second gestures. By providing greater area for gestures, the probability of gesture strokes accidently moving into zones 810 of undesired radial menu items may be reduced.

Furthermore, activating radial menu items as a user performs a first stroke that is outside the bounds of the radial menu item may allow greater precision in the activation of a desired radial menu item. For example, the further the screen pointer 510 is from the center 310, the greater the radial distance that must be travelled by the screen pointer 510 to a zone 810 of an adjacent radial menu item. One skilled in the art will appreciate that allowing a user to move the screen pointer in a wider arcs around the radial menu allows increased precision in activating desired radial menu items.

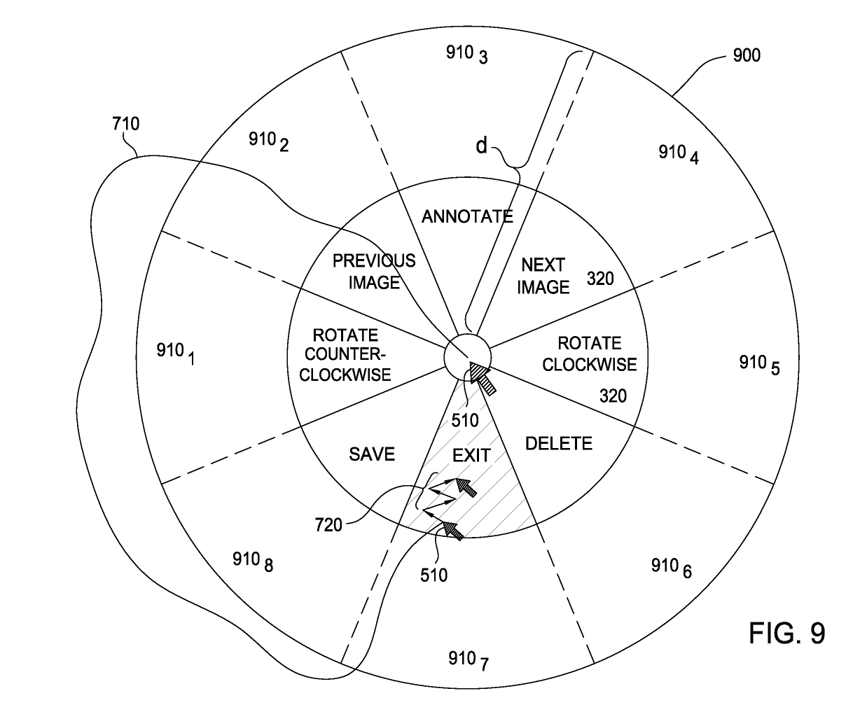

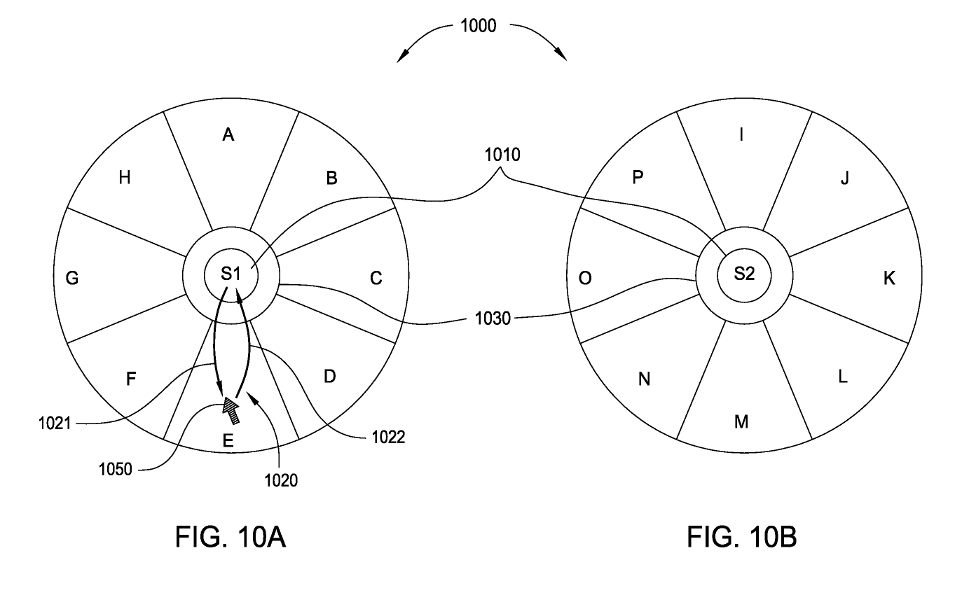

As illustrated in FIG. 8, in some embodiments the zones 810 may extend to the edges of a display area, for example, to the edges of a display screen, an application window, or the like. In an alternative embodiment, a predefined limited selection zone may be defined outside the bounds of the radial menu for receiving selections of radial menu items. FIG. 9 illustrates a circular perimeter 900 around the radial menu 300 that defines a plurality of zones 910₁₋₈ for each of the radial menu items 320. In one embodiment, the perimeter may be made visible to the user, for example, by displaying a solid line, dashed line, shading the zones 910, or the like. The perimeter 900 may have a predefined distance d from the center 310 of the radial menu 300. For example, the perimeter d may be defined by a user in the user preferences 221 illustrated in FIG. 2. While a circular perimeter is shown herein, in alternative embodiments the perimeter 900 may have any reasonable shape that encompasses the radial menu 300. The dimensions of the perimeter may be user configurable in some embodiments.

In one embodiment of the invention, a predefined second stroke as described above, if performed within a zone 910, may result in the selection of a respective radial menu item 320. If a screen pointer is moved outside the perimeter 900, all radial menu items 320 may become inactive. Therefore, if the predefined second strike is performed outside the perimeter 900, a radial menu item 320 may not be selected.

In one embodiment of the invention, selecting a radial menu item 320 may involve performing the first stroke followed by a predefined second stroke as described above. The first stroke may include moving the screen pointer in and out of the perimeter 900. An exemplary first stroke 710 is illustrated in FIG. 9. As illustrated, the first stroke 710 may begin with a movement of the mouse pointer towards a first radial menu item (“Previous Image”). As the screen pointer is moved across the pie slice representing the first radial menu item and the zone 910 associated therewith, the menu manager 215 may activate the first radial menu item. However, when the screen pointer moves outside the perimeter 900, the first radial menu item may be deactivated by the menu manager 215.

As illustrated further in FIG. 9, the first stroke may continue to move the screen pointer outside the perimeter 900 and reenter the perimeter 900 in a zone 910 associated with a second radial menu item (“Rotate Counterclockwise”). When the screen pointer enters the zone 910 associated with the second radial menu item, the menu manager 215 may activate the second menu item. However, when the screen pointer moves outside the perimeter 900 again, the second radial menu item may be deactivated by the menu manager 215.

The screen pointer may be moved in and out of the perimeter 900 several times as described above, which may result in the activation and deactivation of several radial menu items. FIG. 9, depicts the first stroke terminating in a selection zone of a third radial menu item (“Exit”), thereby activating the third radial menu item as illustrated. A predefined second stroke 720 associated with the activated menu item is also shown, which may result in the selection of the third radial menu item. In a particular embodiment, the selection may occur upon the release of a pressed mouse button.

In one embodiment of the invention, moving the screen pointer outside the perimeter 900 may result in the radial menu 300 being removed from the display screen. This may allow a user to cancel or remove the radial menu from the screen in a fluid gesture without additional actions. For example, if a user causes a radial menu to be displayed on the screen (by clicking a mouse button for example), and decides that he no longer wants to make a selection from the radial menu, the user may simply make an elongated straight line first stroke that would take the screen pointer outside the predefined perimeter 900. Upon detecting that the screen pointer is outside the perimeter 900, the menu manager 215 may remove the radial menu from the display screen.

### Overload Radial Menus

The radial menus illustrated herein are generally shown containing 8 “pie slices”. As discussed above, in particular embodiments, the radial menus may be limited to between four and twelve pie slices because, within this range, the greatest accuracy and efficiency for selecting radial menu items may be achieved using gestures described above. However, it is possible that the total number of menu items available for user selection is greater than the number of pie slices in the radial menu. For example, if a total of 14 radial menu items are available, only 8 of the 14 available menu items may be displayed in a radial menu having 8 pie slices. Some embodiments of the invention provide overloaded radial menus that allow a number of menu items greater than the number of pie slices of the radial menu to be displayed in the same radial menu.

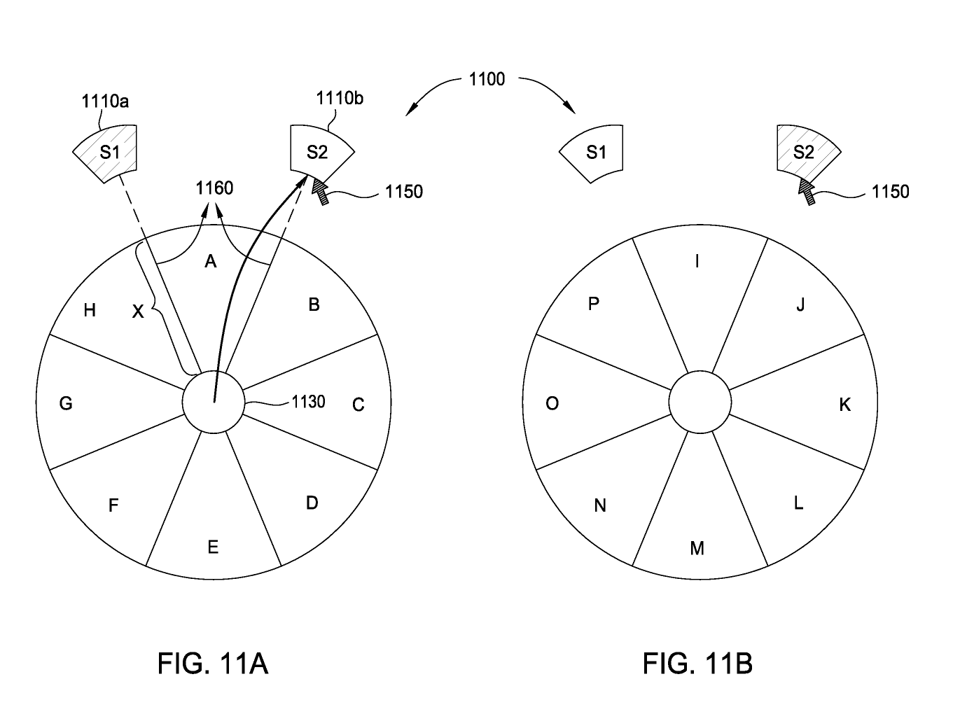

FIG. 10A-B illustrates an exemplary radial menu 1000 comprising a plurality of radial menu items. In FIG. 10A, the radial menu 1000 is shown comprising a first set of radial menu items A-H, and in FIG. 10B, the radial menu 1000 is shown comprising a second ser of radial menu items I-P. Radial menu 1000 may include an activator button 1010 in the center 1030 of the radial menu 1000. Activator button 1010 may indicate which of a plurality of sets of radial menu items are shown in the radial menu 1000. For example, in FIG. 10A, the activator button includes a label ‘S1’ to indicate that the first set of radial menu items are shown in the radial menu 1000.

Likewise, in FIG. 10B, the activator button 1010 includes a label ‘S2’ indicating that the second set of radial menu items are provided in the radial menu 1000. While two sets of radial menu items are illustrated in FIGS. 10A and 10B, in alternative embodiments, a plurality of sets of radial menu items (N) may exist. Accordingly, the radial menu 1000 may be configured to display each of the plurality of sets N including activator buttons S1-SN respectively. Each of the plurality of sets of radial menu items may include at most M radial menu items, wherein M is the number of pie slices in the radial menu. In one embodiment of the invention, a user may be allowed to determine which particular radial menu items are included in each of the plurality of sets via, for example, the user preferences 221.

In one embodiment of the invention, upon the occurrence of a predefined screen pointer event for displaying a radial menu, the menu manager 215 may display the radial menu 1000 with a predefined first set of radial menu items. For example, in one embodiment, upon the occurrence of a predefined screen pointer event for displaying a radial menu, the menu manager 215 may display the radial menu 1000, as shown in FIG. 10A. Thereafter, a first stroke 1020 may be received. As illustrated in FIG. 10A, a first part 1021 the first stroke 1020 may involve moving the screen pointer 1050 away from the activator button 1010 of the radial menu 1000.

After moving the screen pointer 1050 away from the center 1030, if a user desires to view more radial menu items, the user may move the screen pointer 1050 back over the activator button 1010 in the center 1030. For example, FIG. 10A illustrates a second part 1022 of the first stroke 1020 moving the screen pointer back over the activator button 1010. In one embodiment of the invention, if the menu manager detects that the screen pointer 1050 has been moved back over the activator button 1010, the menu manager 215 may display a new set of radial menu items in the radial menu 1000. For example, in a particular embodiment, upon detecting that the screen pointer 1050 has been moved back over the activator button 1010, menu manager 215 may change the radial menu 1000 such that the second set of radial menu items I-P are displayed therein, as illustrated in FIG. 10B.

One skilled in the art will recognize that each time the screen pointer 1050 is moved away from the activator button 1010 and moved back over the activator button 1010, a different set of a plurality of sets of radial menu items may be displayed in the radial menu 1000. In one embodiment, upon detecting that the screen pointer has moved back over the activator button 1010 when a last of a plurality of sets of radial menu items (N) is displayed in the radial menu 1000, the menu manager 215 may loop back and display the first set of radial menu items that was displayed. Accordingly, a user may be able to cycle through the plurality of sets of radial menu items multiple times until a desired radial menu item is determined.

While moving a screen pointer 1050 away from the activator button 1010, and then moving the screen pointer 1050 back over the activator button 1010 is described herein as a method for displaying a new set of radial menu items, in alternative embodiments, any reasonable screen pointer event may result in a new set of radial menu items being displayed in the radial menu 1000. Examples of screen pointer events for displaying a new set of radial menu items in the radial menu may include clicking the activator button 1010, performing a predefined stroke for displaying a new set of radial menu items, and the like. In some embodiments, a new set of radial menu items may be displayed in the radial menu upon receiving a predefined vocal command, or when a predefined one or more keys in a key pad are pressed, and the like.

In one embodiment of the invention, the activator button 1010 may display a label identifying the next set of radial menu items that will be displayed. For example, in FIG. 10A, the activator button 1010 may include a label ‘S2’ (instead of ‘S1’) to indicate that the second set of radial menu items will be displayed when the predefined screen pointer event for displaying a new set of radial menu items in the radial menu occurs.

FIG. 11A illustrates an exemplary radial menu 1100, according to another embodiment of the invention. As illustrated in FIG. 11A, a first set of radial menu items A-H are displayed in the radial menu 1100. Further, as illustrated in FIG. 11A, one or more activator objects 1110 may be displayed a predefined distance X from the center 1130 of the radial menu 1100. In one embodiment of the invention, the distance X may be greater than the distance d defining a selection zone for the radial menu 1100 (See FIG. 9). In one embodiment of the invention, the activator objects 1110 may be placed at different distances X1 and X2 (not shown) from the center to facilitate activation at different “orbits” around the radial menu. While the activator objects 1110 are shown as wedge shaped objects in FIG. 11A, in alternative embodiment, the activator objects 1110 may be any reasonable shape, for example, rectangular, conic, circular, and the like.

The number of activator objects 1110 may correspond to a number of sets (N) of radial menu items. Each of the sets of radial menu items may include at most a number M radial menu items, wherein the number M is equal to the number of pie slices in the radial menu 1100. For purposes of simplicity, it is assumed that two sets ‘S1’ comprising radial menu items A-H, and ‘S2 comprising radial menu items I-P are available. Accordingly, two activator objects 1110a and 1110b are illustrated in FIG. 11A.

In one embodiment of the invention, upon the occurrence of a predefined screen pointer event for displaying a radial menu, the menu manager 215 may display the radial menu 1100 and the one or more activator objects 1110. The radial menu 1100 may initially include a predefined first set of radial menu items. For example, in a particular embodiment, upon the occurrence of a predefined screen pointer event for displaying a radial menu, the menu manager 215 may display the radial menu 1100, as shown in FIG. 11A with menu items A-H.

In some embodiments, the menu manager 215 may be configured to visually distinguish the activator object 1110 associated with the set of radial menu items being displayed in the radial menu 1100 from other activator objects 1110. Accordingly, when the first predefined set S1 of radial menu items is displayed in radial menu 1100, the activator object 1110a may be visually distinguished from activator object 1110b. For example, a different font or style for labels, different shading, size, and the like, may be used to distinguish an activator object.

If a user desires to view a different set of radial menu items, the user may simply move the screen pointer 1150 over one of the activator objects 1110. For example, FIG. 11A illustrates a stroke 1120 that moves the screen pointer from the center 1130 of the radial menu to the activator object 1110b. In one embodiment of the invention, upon detecting that a screen pointer has moved over a given activator object 1110, the menu manager 215 may be configured to populate radial menu 1100 with items associated with the given activator object. For example, in response to detecting the screen pointer being moved over the activator object 1110b in FIG. 11A, menu manager 215 may populate radial menu 1100 with the second set (S2) of radial menu items I-P, as illustrated in FIG. 11B. Further, as illustrated in FIG. 11B, menu manager may visually distinguish the activator object 1110b from the activator object 1110a, as illustrated by the shading of the activator object 1110b in FIG. 11B.

While moving the screen pointer 1150 over an activator object 1110 has been described hereinabove as a screen pointer event that changes the contents of the radial menu 1100, in alternative embodiments any other reasonable screen pointer event such as, for example, clicking a mouse button while the screen pointer is over the activator object 1110, or performing a predefined stroke at or near the activator object 1110, may also be used to change the content of the radial menu 1100.

In one embodiment of the invention, the activator objects 1110 may be placed along the same linear path as lines 1160 dividing the pie slices of the radial menu 1100, as illustrated in FIGS. 11A and 11B. Such a placement may reduce the probability of the screen pointer 1150 accidentally changing the content of the radial menu 1100 while activating/selecting a radial menu item from the radial menu 1100.

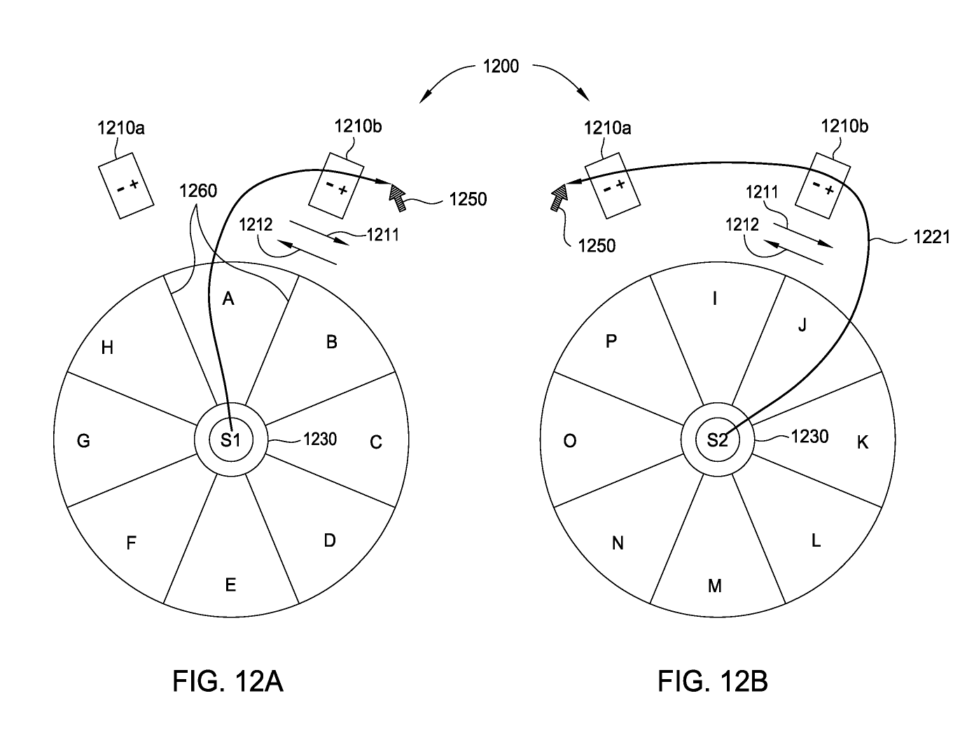

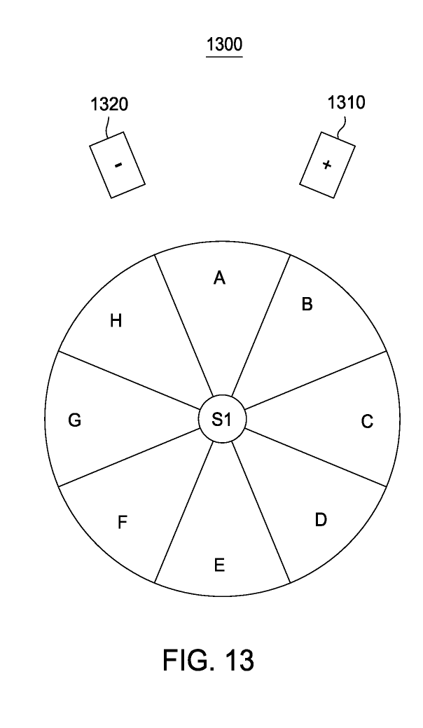

FIG. 12A illustrates a radial menu 1200 according to another embodiment of the invention. As illustrated in FIG. 12A, the radial menu 1200 may include one or more activator objects 1210 associated therewith. The menu manager 215 may be configured to display the one or more activator objects 1210 a predefined distance Z from the center 1230 of the radial menu 1200. In one embodiment of the invention, the distance Z may be greater than the distance d defining a selection zone for the radial menu 1200 (See FIG. 9). While the activator objects 1210 are shown as rectangular shaped objects in FIG. 12A, in alternative embodiments, the activator objects 1210 may be any reasonable shape, for example, wedge, conic, circular, and the like. As with the activator objects 1110 of FIGS. 11A-B, the activator objects 1210 may be placed along the same linear path as lines 1260 dividing the pie slices of the radial menu 1200 to reduce the probability of accidental selection of a radial menu item, as illustrated in FIG. 12A. In some embodiments, the activator objects 1210 may be placed at different distances Z1 and Z2 (not shown in FIG. 12) to activation at different “orbits” around the radial menu.

In one embodiment of the invention, upon receiving a predefined screen pointer event for displaying a radial menu, the menu manager 215 may display the radial menu 1200, and the one or more activator objects 1210 associated therewith. As illustrated in FIG. 12A, the radial menu 1200 may initially include a first predefined set of radial menu items A-H of a plurality of predefined sets of radial menu items. If a user desires to view more radial menu items in the radial menu 1200, the user may move the screen pointer 1250 substantially along a first direction 1211 across the activator object 1210. For example, FIG. 12A illustrates a stroke 1220 that moves the screen pointer 1250 across the activator object 1210b substantially in the first direction 1211.

In response to detecting the screen pointer moving across an activator object 1210 in substantially a first direction 1211 associated with the activator object 1210b, the menu manager 215 may be configured to populate a next set of radial menu items in the radial menu 1200. For example, in response to the stroke 1220, the menu manager 215 may populate a new set of radial menu items I-P in the radial menu 1200. Each time the screen pointer is moved over an activator object 1210 in a first direction associated with the activator object 1210, a different set of radial menu items, for example, Q-X, and so on, may be displayed in the radial menu 1200. In one embodiment, when the screen pointer is moved across an activator 1210 in the first direction when the last of the plurality of sets of radial menu items is displayed in the radial menu, the menu manager 215 may be configured to loop back and display the first set of radial menu items.

In one embodiment of the invention, if the screen pointer 1250 is moved substantially in a second direction 1212 across the activator object 1210, the menu manager 215 may be configured to display an immediately previously displayed set of radial menu items. For example, FIG. 12B illustrates a stroke 1221 that moves the screen pointer 1250 substantially in a second direction 1212 across the activator object 1210b. Upon detecting the screen pointer 1250 moving across the activator object 1210 substantially in the direction 1212, the menu manager 215 may display the items A-H in the radial menu 1200, i.e., the immediately previously displayed set of radial menu items.

In one embodiment of the invention, a single stroke may cross two or more activator objects 1210. For example, the stroke 1221 in FIG. 12B is shown crossing the activator objects 1210b and 1210a. Each time the screen pointer moved across an activator object the content of the radial menu 1200 may be changed based on the direction of movement of the screen pointer 1250 across the activator object. For example, in one embodiment, when the screen pointer moves across the activator object 1210b during the stroke 1221, menu manager 215 may change display radial menu items A-H in the radial menu. Then, when the screen pointer 1250 continues to move across the activator object 1210a, the menu manager 1250 may display the radial menu items I-P (which were displayed immediately previously to the items A-H).

In one embodiment of the invention, the center 1230 of the radial menu 1200 may include an indication of the particular set of the plurality of sets of radial menu items that is displayed in the radial menu 1200. For example, FIG. 12A illustrates a label ‘S1’ in the center 1230 that indicates that the first predefined set of radial menu items A-H are displayed in the radial menu 1200. Likewise, FIG. 12B illustrates a label ‘S2’ in the center 1230 indicate that a second predefined set of radial menu items I-P are displayed in the radial menu 1200.

FIG. 13 illustrates another exemplary radial menu 1300 according to an embodiment of the invention. As illustrated in FIG. 13, in one embodiment, at least one first activator object 1310 and at least one second activator object 1320 distinct from the first activator object may be provided. In one embodiment, moving the screen pointer over the first activator object 1310 may cause a next set of radial menu items to be displayed in the radial menu 1300. In contrast, moving the screen pointer over the second activator object 1320 may cause an immediately previously displayed set of radial menu items to be displayed in the radial menu 1300.

The first activator object 1310 may be visually distinguished from the second activator object 1320. For example, in FIG. 13, the first activator object 1310 is shown with a label ‘+’ to indicate that a next set of radial menu items will be displayed in the radial menu 1300 upon engaging the activator object. The second activator object 1320 is shown with a label ‘−’ to indicate than an immediately previously displayed set of radial menu items will be displayed in the radial menu 1300 upon engaging the activator object. In some embodiments, the activator objects 1310 and 1320 may include text labels such as, for example, “Next”, “Previous”, and the like. In some embodiments, the text labels may describe a name of a menu set that may be displayed upon activation of the activator object.

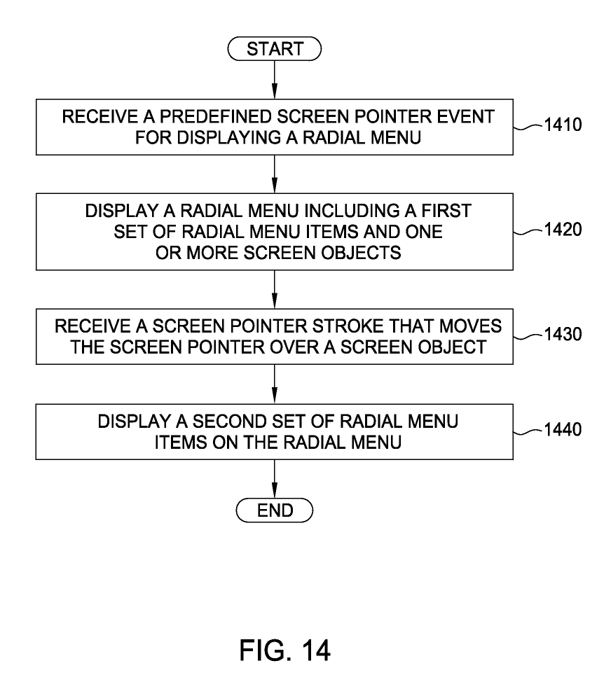

FIG. 14 is a flow diagram of exemplary operation performed by a menu manager 215, according to an embodiment of the invention. The operations may begin in step 1410 by receiving a predefined screen pointer event for displaying a radial menu. Upon receiving the predefined screen pointer event for displaying the radial menu, the menu manager 215 may display a radial menu comprising a first set of radial menu items, and one or more screen objects in step 1420, for example, the activator buttons 1010, or objects 1110, 1210, or 1310 described above.

In step 1430, the menu manager may receive a screen pointer stroke that moves the screen pointer over a screen object. In response to receiving the stroke 1420, menu manager may display a second set of radial menu items in the radial menu, in step 1440.

While the foregoing is directed to embodiments of the present invention, other and further embodiments of the invention may be devised without departing from the basic scope thereof, and the scope thereof is determined by the claims that follow.

What is claimed is:

1. A computer-implemented method of displaying a radial menu, comprising:
receiving a predefined screen pointer event for displaying a radial menu;
in response to receiving the predefined screen pointer event, displaying the radial menu and at least one screen object on a display screen, wherein the displayed radial menu comprises a first set of radial menu items;
receiving a screen pointer gesture, wherein the gesture comprises moving the screen pointer over the at least one screen object; and
in response to detecting that the screen pointer is over the at least one screen object, displaying a second set of radial menu items in the radial menu.

2. The method of claim 1, wherein the at least one screen object is located at a center of the radial menu.

3. The method of claim 2, wherein the screen pointer gesture comprises moving the screen pointer away from the at least one screen object, and then moving the screen pointer back over the at least one screen object, wherein the second set of radial menu items is displayed in the radial menu upon detecting that the screen pointer is moved back over the at least one screen object.

4. The method of claim 1, wherein the at least one screen object is displayed a predefined distance from a center of the radial menu.

5. The method of claim 4, wherein the at least one screen object is displayed along a same linear path as a line dividing radial menu items in the radial menu.

6. The method of claim 4, further comprising displaying two or more screen objects, wherein each screen object is associated with a predefined set of radial menu items.

7. The method of claim 6, wherein moving the screen pointer over one of the two or more screen objects results in a respective predefined set of radial menu items being displayed in the radial menu.

8. The method of claim 4, wherein moving the screen pointer across the at least one screen object in a first direction results in a next set of radial menu items from a plurality of sequential sets of radial menu items to be displayed in the radial menu.

9. The method of claim 8, wherein moving the screen pointer across the at least one screen object in a second direction results in a previous set of radial menu items from the plurality of sets of radial menu items to be displayed in the radial menu.

10. A computer readable storage medium comprising a program product which, when executed by a processor, is configured to perform an operation for displaying a radial menu, comprising:
receiving a predefined screen pointer event for displaying a radial menu;
in response to receiving the predefined screen pointer event, displaying the radial menu and at least one screen object on a display screen, wherein the radial menu comprises a first set of radial menu items;
receiving a screen pointer gesture, wherein the gesture comprises moving the screen pointer over the at least one screen object; and
in response to detecting that the screen pointer is over the at least one screen object, displaying a second set of radial menu items in the radial menu.

11. The computer readable storage medium of claim 10, wherein the at least one screen object is located at a center of the radial menu.

12. The computer readable storage medium of claim 11, wherein the screen pointer gesture comprises moving the screen pointer away from the at least one screen object, and then moving the screen pointer back over the at least one screen object, wherein the second set of radial menu items is displayed in the radial menu upon detecting that the screen pointer is moved back over the at least one screen object.

13. The computer readable storage medium of claim 10, wherein the at least one screen object is displayed a predefined distance from a center of the radial menu.

14. The computer readable storage medium of claim 13, further comprising displaying two or more screen objects, wherein each screen object is associated with a predefined set of radial menu items.

15. The computer readable storage medium of claim 14, wherein the operation further comprises, upon detecting that the screen pointer is over one of the two or more screen objects displaying a respective predefined set of radial menu items in the radial menu.

16. The computer readable storage medium of claim 13, wherein the operation further comprises, upon detecting that the screen pointer has moved across the at least one screen object in a first direction displaying a next set of radial menu items from a plurality of sequential sets of radial menu items in the radial menu.

17. The computer readable storage medium of claim 16, wherein the operation further comprises, upon detecting that the screen pointer has moved across the at least one screen object in a second direction displaying a previous set of radial menu items from the plurality of sets of radial menu items in the radial menu.

18. A system, comprising:
a memory comprising a program; and
a processor which, when executing the program, is configured to:
receive a predefined screen pointer event for displaying a radial menu;
in response to receiving the predefined screen pointer event, display the radial menu and at least one screen object on a display screen, wherein the radial menu comprises a first set of radial menu items;
receive a screen pointer gesture, wherein the gesture comprises moving the screen pointer over the at least one screen object; and
in response to detecting that the screen pointer is over the at least one screen object, display a second set of radial menu items in the radial menu.

19. The system of claim 18, wherein the at least one screen object is located at a center of the radial menu.

20. The system of claim 19, wherein the screen pointer gesture comprises moving the screen pointer away from the at least one screen object, and then moving the screen pointer back over the at least one screen object, wherein the second set of radial menu items is displayed in the radial menu upon detecting that the screen pointer is moved back over the at least one screen object.

21. The system of claim 18, wherein the processor is configured to display the at least one screen object a predefined distance from a center of the radial menu.

22. The system of claim 21, wherein the processor is configured to displaying two or more screen objects, wherein each screen object is associated with a predefined set of radial menu items.

23. The system of claim 22, wherein upon detecting that the screen pointer is over one of the two or more screen objects, the processor is configured to display a respective predefined set of radial menu items in the radial menu.

24. The system of claim 21, wherein upon detecting that the screen pointer has moved across the at least one screen object in a first direction, the processor is configured to display a next set of radial menu items from a plurality of sequential sets of radial menu items in the radial menu.

25. The system of claim 24, wherein upon detecting that the screen pointer has moved across the at least one screen object in a second direction, the processor is configured to display a previous set of radial menu items from the plurality of sets of radial menu items in the radial menu.
